(19) United States
(12) Patent Application Publication
(10) Pub. No.: US 2021/0075153 A1
(43) Pub. Date: Mar. 11, 2021

(54) CONNECTOR HOLDING STRUCTURE AND ELECTRONIC DEVICE

(71) Applicant: Mitsubishi Electric Corporation, Tokyo (JP)

(72) Inventor: Yoichi MATSUO, Tokyo (JP)

(73) Assignee: Mitsubishi Electric Corporation, Tokyo (JP)

(21) Appl. No.: 16/622,214

(22) PCT Filed: May 21, 2018
(86) PCT No.: PCT/JP2018/019527

§ 371 Date: Dec. 12, 2019

(51) Int. Cl. H01R 13/60

(52) U.S. Cl. CPC H01R 13/60

(57) ABSTRACT

A connector holding structure includes: a casing; an electric wire drawn from an inside to an outside of the casing; a connector connected at one end to the electric wire and including a projection at another end; an electric wire hanger provided on one side of the casing and holding a midway portion of the electric wire; and a holder provided on one side of the casing and having a recess detachably holding the connector by allowing the projection to fit into the recess. The holder is provided on the one side such that the holder is rotatable around a central axis of the holder extending in a direction in which the projection is fitted into the recess.

### FIELD

The present invention relates to a connector holding structure for a connector connected to a tip of an electric wire connected to an electronic device and to an electronic device that includes the connector holding structure.

### BACKGROUND

Conventional electronic devices such as electric vehicles or storage batteries use a structure in which a connector is inserted into a holder secured to an electronic device, as a connector holding structure for holding an electric wire connected to an electronic device and a connector attached to the tip of the electric wire.

Patent literature 1, for example, discloses an electric vehicle charging station in which a holder attached to the outer portion of a station body holds a charging gun, functioning as a connector to be electrically connected to an electric vehicle, and in which an excess length of an electric cable, i.e., part of a charging cable formed of the electric cable, is wound around and held by the winding part of the holder.

### CITATION LIST

### Patent Literature

Patent Literature 1: Japanese Patent Application Laid-open No. 2013-94040

### SUMMARY

### Technical Problem

With the technique disclosed in Patent Literature 1 described above, when the charging gun is held by the holder, part of the charging cable is wound around and held by the holder. In such a case, the charging cable is twisted and thus becomes difficult to wind; therefore, there is a problem in that it is necessary to wind the charging cable while at the same time eliminating twisting of the charging cable and that twisting may remain in the charging cable.

The present invention has been achieved in view of the above and an object of the present invention is to provide a connector holding structure that can hold a connector such that twisting of an electric wire connected to the connector is easily eliminated.

### Solution to Problem

In order to solve the above problems and achieve the object, a connector holding structure according to an aspect of the present invention includes: a casing; an electric wire drawn from an inside to an outside of the casing; a connector connected at one end to the electric wire and including a projection at another end; an electric wire hanger provided on one side of the casing and holding a midway portion of the electric wire; and a holder provided on one side of the casing and having a recess detachably holding the connector by allowing the projection to fit into the recess. The holder is provided on the one side such that the holder is rotatable around a central axis of the holder extending in a direction in which the projection is fitted into the recess.

### Advantageous Effects of Invention

A connector holding structure according to the present invention produces an effect where a connector can be held such that twisting of an electric wire connected to the connector is easily eliminated.

### BRIEF DESCRIPTION OF DRAWINGS

FIG. 1 is a front view of an electronic device that includes a connector holding structure according to a first embodiment of the present invention.

FIG. 2 is a side view of the electronic device according to the first embodiment of the present invention.

FIG. 3 is a partially enlarged view of the connector holding structure of the electronic device according to the first embodiment of the present invention in which a connector is connected to a holder.

FIG. 4 is a partially enlarged view of the connector holding structure of the electronic device according to the first embodiment of the present invention in which the connector is disconnected from the holder.

FIG. 5 is a front view of an electronic device that includes a connector holding structure according to a second embodiment of the present invention.

FIG. 6 is a side view of the electronic device according to the second embodiment of the present invention.

FIG. 7 is a front view of an electronic device that includes a connector holding structure according to a third embodiment of the present invention.

FIG. 8 is a side view of the electronic device according to the third embodiment of the present invention.

FIG. 9 is a front view of a connector holding structure according to a fourth embodiment of the present invention in which the connector is connected to the holder.

FIG. 10 is an enlarged cross-sectional view of a rotation support part in the connector holding structure according to the fourth embodiment of the present invention taken along the central line of the holder.

FIG. 11 is a partially enlarged view of a connector holding structure according to a fifth embodiment of the present invention in which the connector is connected to the holder.

FIG. 12 is a partially enlarged view of the connector holding structure according to the fifth embodiment of the present invention in which the holder to which the connector is connected is tilted.

### DESCRIPTION OF EMBODIMENTS

A connector holding structure and an electronic device according to embodiments of the present invention will be described below in detail with reference to the drawings. This invention is not limited to the embodiments.

### First Embodiment

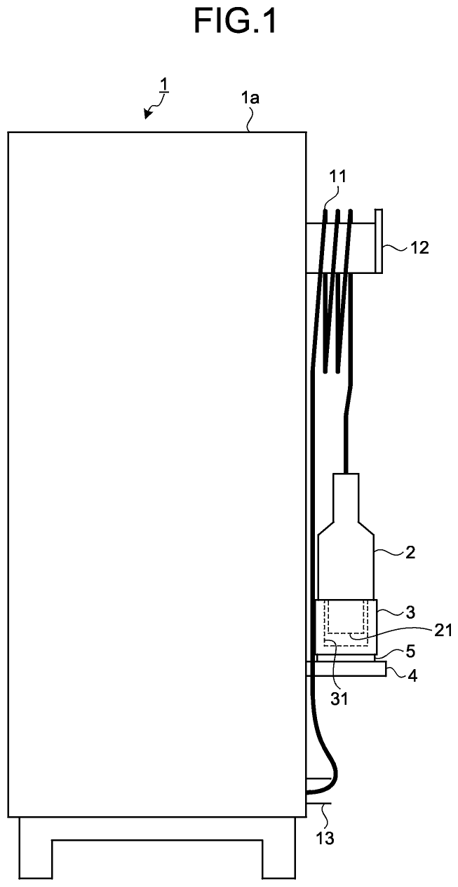

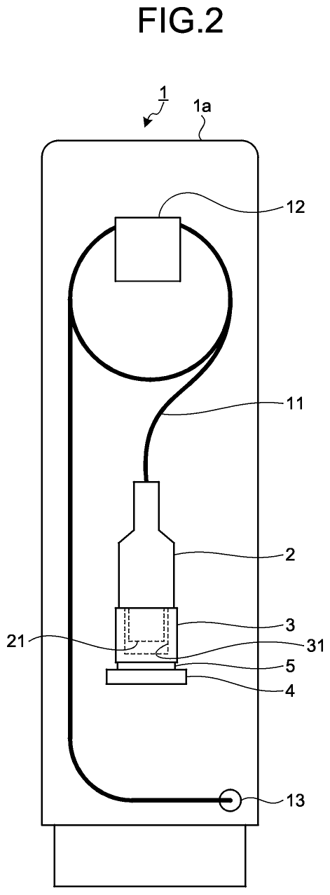

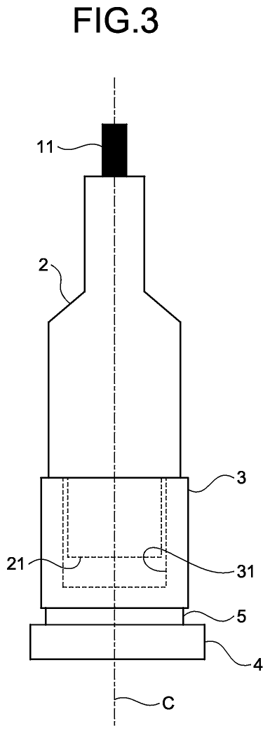

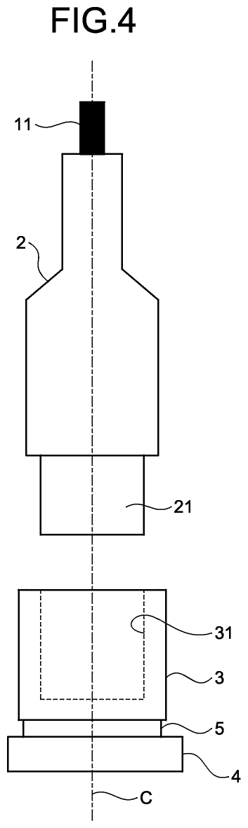

FIG. 1 is a front view of an electronic device 1 that includes a connector holding structure according to a first embodiment of the present invention. FIG. 2 is a side view of the electronic device 1 according to the first embodiment of the present invention. FIG. 3 is a partially enlarged view of the connector holding structure of the electronic device 1 according to the first embodiment of the present invention in which a connector is connected to a holder. FIG. 4 is a partially enlarged view of the connector holding structure of the electronic device 1 according to the first embodiment of the present invention in which the connector is disconnected from the holder.

The electronic device 1 according to the first embodiment includes the connector holding structure according to the first embodiment. The connector holding structure according to the first embodiment is a connector holding structure that holds a connector attached to an end of an electric wire drawn from the inside to the outside of the casing, and it includes a cuboid (box-shaped) casing 1a that is an electronic-device main body accommodating various types of electronic components (not illustrated); an electric wire 11 connected to the electronic components in the casing 1a; and an electric wire hanger 12 that is provided on one side of the casing 1a and supports a midway portion of the electric wire 11. The connector holding structure further includes a tubular connector 2 connected at one end to the electric wire 11 and having a projection 21 at the tip of the other end; a holder 3 provided on one side of the casing 1a and having a recess 31 for detachably holding the connector by allowing the projection 21 of the connector 2 to fit therein; a holder base 4 which is provided on one side of the electronic device 1 and to which the holder 3 is secured; and a rotation support part 5 that couples the holder 3 and the holder base 4.

One end of the electric wire 11 is drawn from the inside to the outside of the casing 1a through an electric wire outlet 13 provided in the lower part of one side of the casing 1a. The electric wire 11 is connected at the other end to the electronic components in the casing 1a. Examples of the electric wire 11 include a flexible cord that is a conductor, such as copper, covered with an insulating coating and a flexible cable that is a conductor, such as copper, covered with an insulating coating, which is further covered with a cover referred to as a sheath.

When the electronic device 1 is in use, the connector 2 is connected to a connection target connector to which the connector 2 is to be connected and is thus electrically connected to the connection target connector. The connector 2 is connected at one end to the electric wire 11. This means that the connector 2 accommodates therein one end of the electric wire 11. The electric wire 11 is drawn out of the connector 2 from one end of the connector 2. The connector 2 has a tubular shape extending in a direction along the central axis of the electric wire 11 drawn from one end of the connector 2. In the first embodiment, the connector 2 has, for example, a cylindrical shape that is easy to hold; however, the connector 2 is not limited to any particular shape.

The connector 2 is provided with the projection 21 at the other end. The projection 21 has a shape corresponding to the connection target connector to which the connector 2 is connected when the electronic device 1 is in use. The projection 21 is provided such that it projects in a direction opposite to the direction in which the electric wire 11 is drawn from the connector 2. The projection 21, for example, has a cylindrical shape or a prismatic shape; however, the projection 21 is not limited to any particular shape.

The holder 3 is provided on one side of the electronic device 1 and holds the connector 2 when the electronic device 1 is not in use. The holder 3 has the recess 31 on its upper surface. When the connector 2 is accommodated in the holder 3, the projection 21 of the connector 2 fits into the recess 31. The holder 3 detachably holds the connector 2 by allowing the projection 21 of the connector 2 to fit into the recess 31. In other words, when the projection 21 of the connector 2 is inserted into the recess 31 of the holder 3, the projection 21 fits into the recess 31 and thus the connector 2 is held by the holder 3. The mating structure of the recess 31 and the projection 21 is not particularly limited as long as it can secure the recess 31 and the projection 21 in place. For example, the connector 2 is held by the holder 3 by fitting a securing projection of the projection 21 into a securing groove in the recess 31. Thus, the holder 3 functions as a connector holding unit that detachably holds the connector 2 by allowing the connector 2 to fit therein. The holder 3 is secured to one side of the electronic device 1 via the holder base 4.

The recess 31 has, for example, approximately the same shape as the connection target connector to which the connector 2 is connected. However, the shape of the recess 31 is not limited as long as it can hold the connector 2 when the projection 21 of the connector 2 fits into the recess 31. In the first embodiment, the holder 3 is disposed such that the recess 31 opens vertically upward. In other words, in the first embodiment, the holder 3 is placed with the recess 31 facing upward.

The holder base 4 is secured to one side of the electronic device 1 in a state of projecting therefrom. The rotation support part 5 is secured to the upper surface of the holder base 4. The holder base 4 is not limited to any particular shape as long as the rotation support part 5 can be secured thereto and the holder base 4 can hold the rotation support part 5 and the holder 3.

The rotation support part 5 is secured to the holder base 4 at its lower portion and is secured to the holder 3 at its upper portion. The rotation support part 5 couples the holder 3 and the holder base 4 such that the holder 3 can rotate around a central axis C of the holder that extends in a direction in which the projection 21 of the connector 2 is fitted, or inserted, into the recess 31 of the holder 3. The holder base 4 secured to one side of the electronic device 1 does not move. The holder 3 can be rotatably held by the holder base 4 and the rotation support part 5.

The rotation support part 5 can be configured from, for example, a bearing that includes an outer ring, an inner ring, a moving body disposed between the outer ring and the inner ring, and a retainer that positions the moving body such that rolling elements can rotate correctly between the outer ring and the inner ring. In this case, the outer ring is secured to the holder base 4. Furthermore, the inner ring is secured to the surface of the holder 3 facing the holder base 4. The moving body is configured from balls or rollers.

In the first embodiment, in a state where the connector 2 is connected to the holder 3, the tubular central axis that is the central axis of the cylindrical shape of the connector 2, the central axis of the electric wire 11 at one end of the connector 2 from which the electric wire 11 is drawn, the central axis C of the holder, the central axis of the recess 31 of the holder 3, and the central axis of the bearing that is the rotation support part 5 are coaxial to one another. The central axis C of the holder extends in the vertical direction. The holder 3 is held to be rotatable around the central axis C of the holder.

The electric wire hanger 12, secured to one side of the electronic device 1, has an L shape such that it projects from the one side of the electronic device 1 and is bent and extends upward at its free end portion. The electric wire hanger 12 is secured to one side of the electronic device 1 by a method such as welding so as to have enough strength to withstand the weight of the electric wire 11 wound around the electric wire hanger 12. When the connector 2 is accommodated in the holder 3, the midway portion of the electric wire 11 between the electric wire outlet 13 and one end of the connector 2 is hooked on and wound around the electric wire hanger 12 and thus the electric wire hanger 12 holds the midway portion of the electric wire 11.

With the electronic device 1 configured as above, when the electronic device 1 is not in use, the connector 2 is attached to the holder 3 so that the holder 3 holds the connector 2. Moreover, the midway portion of the electric wire 11 is wound around the electric wire hanger 12 so that the electric wire 11 is supported by the electric wire hanger 12. Alternatively, the midway portion of the electric wire 11 is bundled in a spiral shape and the central portion of the spiral is hooked on the electric wire hanger 12, whereby the electric wire 11 is supported by the electric wire hanger 12. Consequently, the electric wire 11 and the connector 2 are accommodated in an orderly fashion in the holder 3 and the electric wire hanger 12 on one side of the electronic device 1.

The electric wire 11 and the connector 2 are accommodated by first fitting the projection 21 at the tip of the connector 2 into the recess 31 of the holder 3 and then by winding the electric wire 11 around the electric wire hanger 12 or bundling the midway portion of the electric wire 11 into a spiral shape and hooking the central portion of the spiral on the electric wire hanger 12. However, because the electric wire 11 is drawn from the electric wire outlet 13 and the other end of the electric wire 11 is thus secured by the electric wire outlet 13, the action described above causes twisting of the electric wire 11.

With the connector holding structure according to the first embodiment, before the electric wire 11 is wound around the electric wire hanger 12, the connector 2 is fitted into and secured to the holder 3. The holder 3 is rotatable around the central axis C of the holder extending in a direction in which the projection 21 of the connector 2 is fitted into the recess 31 of the holder 3. The connector 2 fitted into and secured to the holder 3 rotates with the rotation of the holder 3. In other words, the connector 2 rotates together with the holder 3. Consequently, twisting of the electric wire 11 can be automatically eliminated after the connector 2 is fitted into the holder 3.

Thus, with the connector holding structure according to the first embodiment, it is not necessary to wind the electric wire 11 around the electric wire hanger 12 while at the same time eliminating twisting of the electric wire 11. This means that it is only necessary to simply wind the electric wire 11 around the electric wire hanger 12; therefore, an operation of accommodating the electric wire 11 is facilitated. Moreover, it is possible to avoid such a situation that the connector 2 drags on the ground during the operation of eliminating twisting of the electric wire 11 and thus the connector 2 is damaged. Moreover, no twisting remains in the electric wire 11 that is wound around the electric wire hanger 12; therefore, the electric wire 11 can be accommodated in a stable state, i.e., with twisting being eliminated therefrom.

In an electronic device that does not have the connector holding structure according to the first embodiment, twisting of an electric wire is not automatically eliminated. Thus, when an electric wire is wound and is twisted, a force acts on the electric wire to return it to an untwisted state. This makes the operation of winding the electric wire around the electric wire hanger difficult. Moreover, when an operator releases the connector so that the connector can freely rotate and thus elimination of twisting of the electric wire is facilitated, the connector may drop on the ground and may be damaged. Moreover, if the connector is placed on the ground and then the electric wire is wound around the electric wire hanger, the connector and the electric wire may drag on the ground with the rotation of the connector and thus the connector and the electric wire may be damaged.

With the connector holding structure according to the first embodiment, even if the electric wire 11 is first wound around the electric wire hanger 12 and then the connector 2 is inserted into the holder 3 without twisting of the electric wire 11 being eliminated, the connector 2 can still be held by the holder 3 with no twisting remaining in the electric wire 11. Thus, it is possible to automatically solve the unstable state of the electric wire 11 attributed to twisting of the electric wire 11.

One example of the electronic device 1 described above is a power converter that supplies power to a power storage device. When the electronic device 1 is a power converter, the connector 2 is a connector that is to be electrically connected to the connector of a power storage device and the electric wire 11 is a charging/discharging cable that electrically connects the power storage device and the power converter with each other and functions as a feeding path to the power storage device. The connection target connector to which the connector 2 is connected is, for example, a charging port of an electric vehicle.

The description has been given above of a case where the casing 1a has a cuboid shape; however, the casing 1a is not limited to any particular shape.

Moreover, the description has been given above of a case where the central axis C of the holder extends in the vertical direction; however, the central axis C of the holder may extend in any direction other than the vertical direction.

As described above, with the holding structure according to the first embodiment, when the electric wire 11 drawn out of the casing 1a in the electronic device 1 and the connector 2 attached to the tip of the electric wire 11 are accommodated, the holder 3 and the connector 2 can rotate together around the central axis C of the holder extending in a direction in which the projection 21 of the connector 2 is fitted into the recess 31 of the holder 3. Thus, with the holding structure according to the first embodiment, twisting of the electric wire 11 can be automatically eliminated after the connector 2 is fitted into the holder 3 and this facilitates the operation of accommodating the electric wire 11. Moreover, with the holding structure according to the first embodiment, the electric wire 11 and the connector 2 can be accommodated without dragging on the ground; therefore, the connector 2 and the electric wire 11 can be prevented from being damaged.

Therefore, the connector holding structure according to the first embodiment can facilitate the operation of winding the electric wire 11 and can hold the connector 2 such that twisting of the electric wire 11 connected to the connector 2 is easily eliminated.

### Second Embodiment

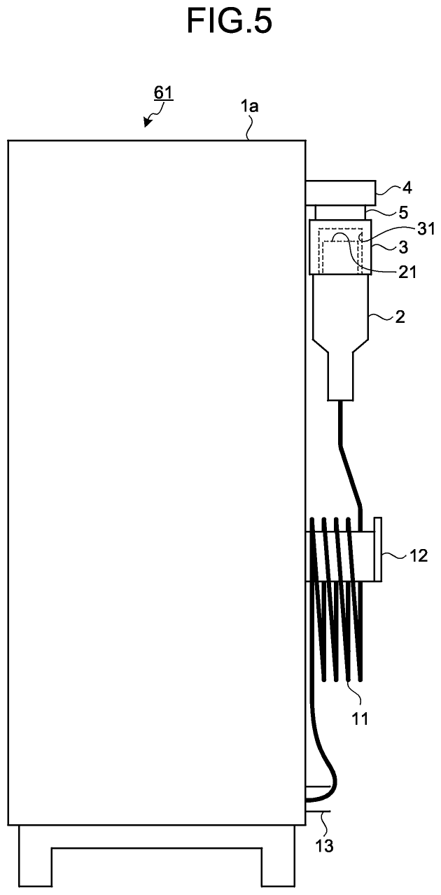

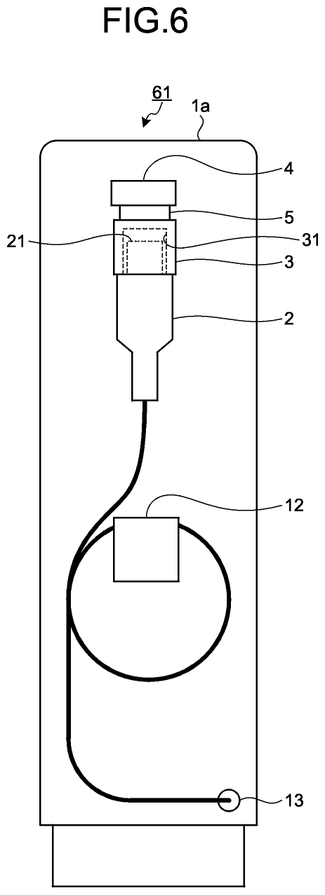

FIG. 5 is a front view of an electronic device 61 that includes a connector holding structure according to a second embodiment of the present invention. FIG. 6 is a side view of the electronic device 61 according to the second embodiment of the present invention. FIGS. 5 and 6 illustrate an example of the connector holding structure with which the projection 21 of the connector 2 is fitted into the recess 31 of the holder 3 from below the holder 3. In the first embodiment described above, a description has been given of a form in which the projection 21 of the connector 2 is fitted into the recess 31 of the holder 3 from above the holder 3; however, the direction in which the projection 21 of the connector 2 is fitted into the recess 31 of the holder 3 is not limited thereto.

As illustrated in FIGS. 5 and 6, in the electronic device 61 according to the second embodiment, the holder 3, the holder base 4, and the rotation support part 5 are disposed above the electric wire hanger 12 on one side of the electronic device 61. The rotation support part 5 and the holder 3 are disposed, in the order they appear in this sentence, on the lower surface of the holder base 4. The holder 3 is disposed such that the recess 31 opens vertically downward. In other words, in the second embodiment, the holder 3 is placed with the recess 31 facing downward.

With the connector holding structure and the electronic device 61 according to the second embodiment configured as above, when the connector 2 is accommodated in the holder 3 during non-use of the electronic device 61, the connector 2 is held by the holder 3 by fitting the projection 21 of the connector 2 into the recess 31 of the holder 3 from below the holder 3. Moreover, the midway portion of the electric wire 11 is wound around the electric wire hanger 12 so that the electric wire 11 is supported by the electric wire hanger 12. Alternatively, the midway portion of the electric wire 11 is bundled in a spiral shape and the central portion of the spiral is hooked on the electric wire hanger 12, whereby the electric wire 11 is supported by the electric wire hanger 12. Consequently, with the electronic device 61 according to the second embodiment as well, the electric wire 11 and the connector 2 are accommodated in an orderly fashion in the holder 3 and the electric wire hanger 12 on one side of the electronic device 61.

The connector holding structure and the electronic device 61 according to the second embodiment described above can provide an effect similar to that in the first embodiment.

Furthermore, the connector holding structure and the electronic device 61 according to the second embodiment can provide an effect where when the projection 21 of the connector 2 is not inserted into the recess 31 of the holder 3, water and foreign matter can be prevented from being accumulated in the recess 31 of the holder 3. For example, if the electronic device 61 is a power converter that supplies power to an electric vehicle, when the projection 21 of the connector 2 is not inserted into the recess 31 of the holder 3, such as when the connector 2 is connected to the electric vehicle, water and foreign matter can be prevented from being accumulated in the recess 31 of the holder 3.

### Third Embodiment

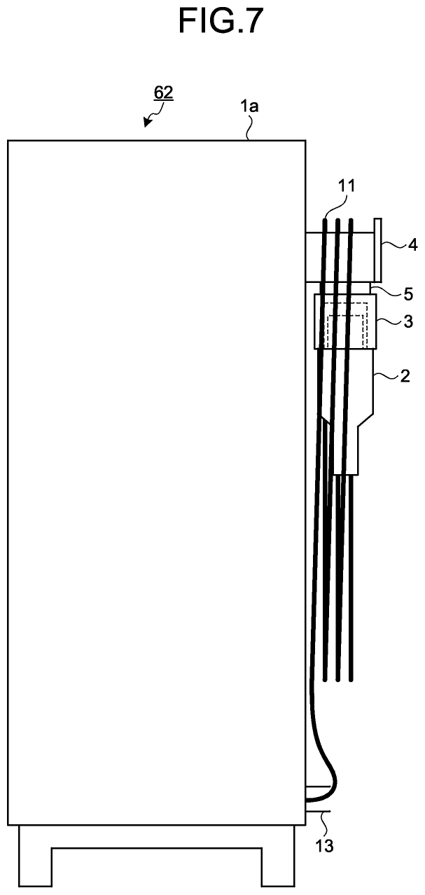

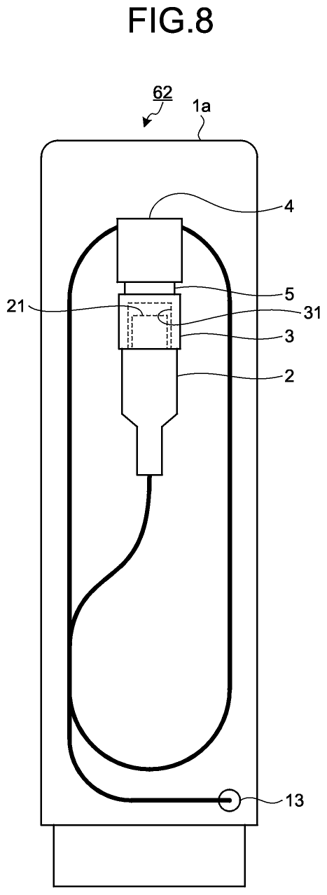

FIG. 7 is a front view of an electronic device 62 that includes a connector holding structure according to a third embodiment of the present invention. FIG. 8 is a side view of the electronic device 62 according to the third embodiment of the present invention. FIGS. 7 and 8 illustrate an example of the connector holding structure in which the holder base 4 serves also as the electric wire hanger 12. In the second embodiment described above, a description has been given of a case where the holder base 4 and the electric wire hanger 12 are provided separately; however, the holder base 4 and the electric wire hanger 12 may be the same component.

As illustrated in FIGS. 7 and 8, with the electronic device 62 according to the third embodiment, the holder base 4 serves also as the electric wire hanger 12. Thus, the electric wire hanger 12 provided below the holder 3, the holder base 4, and the rotation support part 5 in the electronic device 61 in the second embodiment is removed. With this configuration, the holder base 4 preferably has an L shape such that it projects from one side of the electronic device 62 and is bent and extends upward at its free end portion in a similar manner to the electric wire hanger 12. The midway portion of the electric wire 11 is hooked on and supported by the holder base 4 serving also as the electric wire hanger 12.

The connector holding structure and the electronic device 62 according to the third embodiment described above can provide an effect similar to that in the second embodiment.

Moreover, in the connector holding structure and the electronic device 62 according to the third embodiment, the holder base 4 serves also as the electric wire hanger 12 and thus the electric wire hanger 12 is removed. Consequently, the number of components is reduced; therefore, the material cost and the processing cost can be reduced.

### Fourth Embodiment

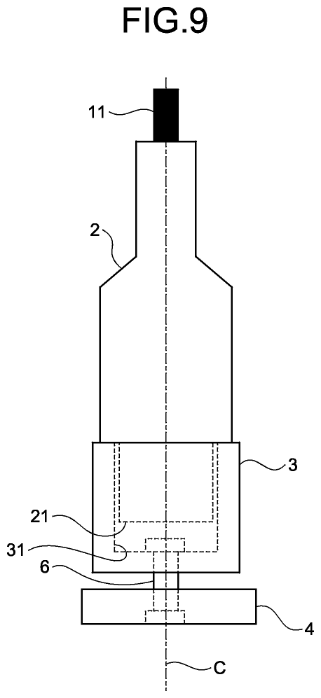

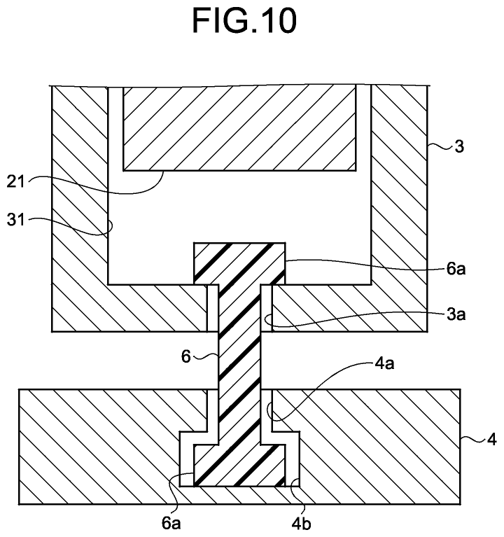

FIG. 9 is a front view of a connector holding structure according to a fourth embodiment of the present invention in which the connector 2 is connected to the holder 3. FIG. 10 is an enlarged cross-sectional view of the rotation support part 5 in the connector holding structure according to the fourth embodiment of the present invention taken along the central line of the holder 3. In the first to third embodiments, descriptions have been given of a case where a bearing is used for the rotation support part 5 in the connector holding structure; however, the rotation support part 5 is not limited to a bearing. The rotation support part 5 may be configured from, depending on the specifications required for the electronic device 1, a holder hole 3a provided in the holder 3, a holder base recess 4a provided in the holder base 4, and a bar-like securing part 6 as illustrated in FIGS. 9 and 10.

In the connector holding structure according to the fourth embodiment illustrated in FIG. 9, the bar-like securing part 6 having a columnar shape includes disk-shaped enlarged diameter portions 6a at opposite ends in the central axis direction of the columnar shape. The enlarged diameter portions 6a have a larger diameter than the other portions of the bar-like securing part 6.

The holder hole 3a, bored into the central portion of the end surface of the holder 3 facing the holder base 4, is a cylindrical hole communicating with the recess 31. The holder base recess 4a is a cylindrical hole bored into the central portion of the end surface of the holder base 4 facing the holder 3. The holder base recess 4a has, in its bottom portion, an enlarged diameter recess portion 4b that has an enlarged size that allows the enlarged diameter portion 6a of the bar-like securing part 6 to be accommodated therein.

The holder 3 has, in its side surface of a part closer to the holder base 4, a groove (not illustrated) which communicates with the holder hole 3a and into which one end of the bar-like securing part 6 can be inserted. In a similar manner, the holder base 4 has, in its side surface of a part closer to the holder 3, a groove (not illustrated) which communicates with the holder base recess 4a and into which the other end of the bar-like securing part 6 can be inserted. The assembly structure of the holder 3, the securing part 6, and the holder base 4 is not limited to the above configuration. For example, the enlarged diameter recess portion 4b of the holder base 4 penetrates the holder base 4 to reach the end surface of the holder base 4 that faces away from the end surface of the holder base 4 facing the holder 3. In the securing part 6, the enlarged diameter portions 6a provided at opposite ends in the central axis direction of the columnar shape are attachable to and detachable from the main body of the securing part 6, i.e., a portion of the securing part 6 excluding the enlarged diameter portions 6a. In such a case, opposite end portions of the main body in the central axis direction of the columnar shape are externally threaded. Moreover, the surfaces of the enlarged diameter portions 6a attached to and detached from the main body have internal threads. With this configuration, the main body of the securing part 6 is inserted into the holder hole 3a, the holder base recess 4a, and the enlarged diameter recess portion 4b, and the enlarged diameter portions 6a are screwed into the opposite end portions of the main body, whereby the holder 3 and the holder base 4 can be coupled by the securing part 6.

When the holder 3 and the holder base 4 are coupled, one end of the bar-like securing part 6 is inserted and placed in the holder hole 3a via the groove of the holder 3 and the other end of the bar-like securing part 6 is inserted and placed in the holder base recess 4a via the groove of the holder base 4. In this state, the central axis of the bar-like securing part 6, the central axis of the cylindrical holder hole 3a, and the central axis of the cylindrical holder base recess 4a are coaxial with one another. Consequently, the enlarged diameter portion 6a at one end of the bar-like securing part 6 is fitted into and hooked on the bottom surface of the recess 31 with which the holder hole 3a communicates and the enlarged diameter portion 6a at the other end of the bar-like securing part 6 is fitted into and hooked on the enlarged diameter recess portion 4b in the bottom portion of the holder base recess 4a; therefore, the holder 3 and the holder base 4 are secured in the direction in which the central axis of the holder hole 3a and the central axis of the holder base recess 4a extend. The holder 3 can rotate, relative to the holder base 4, around the central axis of the holder hole 3a and the central axis of the holder base recess 4a. The simplified configuration of the rotation support part 5 using the bar-like securing part 6 is not limited to that described above. The securing part 6 may be secured to either the holder 3 or the holder base 4.

The connector holding structure according to the fourth embodiment described above can provide an effect similar to that in the first embodiment.

Moreover, in the connector holding structure according to the fourth embodiment, the rotation support part 5 is configured by a simple structure in which the bar-like securing part 6 is inserted into the holder hole 3a of the holder 3 and the holder base recess 4a of the holder base 4; therefore, the material cost can be reduced.

### Fifth Embodiment

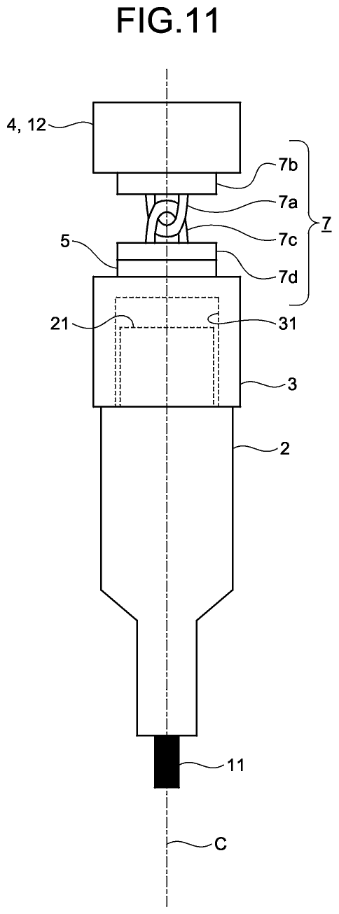

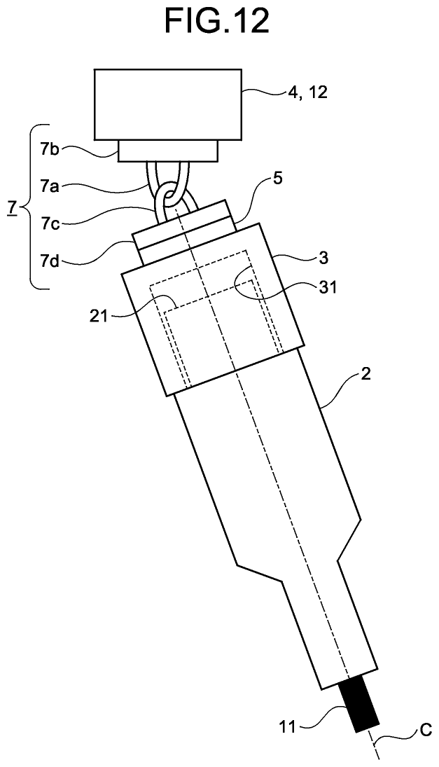

FIG. 11 is a partially enlarged view of a connector holding structure according to a fifth embodiment of the present invention in which the connector 2 is connected to the holder 3. FIG. 12 is a partially enlarged view of the connector holding structure according to the fifth embodiment of the present invention in which the holder 3 to which the connector 2 is connected is tilted. Specifically, FIG. 12 illustrates an example of a state where the holder 3 is tilted in a direction tilted relative to the rotation axis of a bearing that is the rotation support part 5 in the connector holding structure according to the fifth embodiment.

In the connector holding structure according to the second embodiment, when the connector 2 is accommodated in the holder 3 at a proper position, the tubular central axis that is the central axis of the cylindrical shape of the connector 2, the central axis of the electric wire 11 at one end of the connector 2 from which the electric wire 11 is drawn, the central axis C of the holder, the central axis of the recess 31 of the holder 3, and the central axis of the bearing that is the rotation support part 5 are coaxial to one another. As illustrated in FIGS. 11 and 12, for example, a coupling structure 7 having two U-shaped hooks entwined with each other may be used as a coupling structure between the holder base 4 and a bearing that is the rotation support part 5.

The coupling structure 7 is configured to include a holder-base-side hook 7a that is a U-shaped first hook; a holder-base-side base part 7b that is a first base part; a rotation-support-part-side hook 7c that is a U-shaped second hook; and a rotation-support-part-side base part 7d that is a second base part. The tip portions on both sides of the holder-base-side hook 7a are secured to the holder-base-side base part 7b secured to the surface of the holder base 4 facing the rotation support part 5. The tip portions on both sides of the rotation-support-part-side hook 7c are secured to the rotation-support-part-side base part 7d secured to the surface of the bearing, i.e., the rotation support part 5, facing the holder base 4. The holder-base-side hook 7a and the rotation-support-part-side hook 7c are secured such that the U shapes are entwined with each other.

In the coupling structure 7 configured as above, in a state where the connector 2 is held by the holder 3, even when the connector 2 swings such that the rotation axis of the bearing, i.e., the rotation support part 5, and the central axis of the connector 2 are tilted relative to the vertical direction, the rotation-support-part-side hook 7c is moved relative to the holder-base-side hook 7a. Thus, with the coupling structure 7, even when the rotation axis of the bearing, i.e., the rotation support part 5, is tilted relative to the vertical direction due to the swinging of the connector 2, the connector 2 can be held by the holder 3 without causing the holding state of the connector 2 by the holder 3 unstable. Moreover, when the electric wire 11 is wound onto the electric wire hanger 12, twisting of the electric wire 11 can be eliminated more smoothly.

The description has been given above of a case where a U-shaped hook is attached to the holder base 4; however, an effect similar to the above can still be obtained when the holder base 4 serves also as the electric wire hanger 12 and the electric wire hanger 12 is omitted as in the case of the third embodiment.

The connector holding structure according to the fifth embodiment described above can provide an effect similar to that in the first embodiment.

Moreover, the connector holding structure according to the fifth embodiment includes the coupling structure 7; therefore, the connector 2 can be definitely held by the holder 3 even when the connector 2 held by the holder 3 swings and twisting of the electric wire 11 caused when the electric wire 11 is wound onto the electric wire hanger 12 can be eliminated more smoothly.

### Sixth Embodiment

In the fifth embodiment described above, a description has been given of a case where U-shaped hooks are used as components to provide a connector holding structure with which the connector 2 can be held by the holder 3 even when the rotation axis of the bearing, i.e., the rotation support part 5, is tilted relative to the vertical direction due to the swinging of the connector 2. The bearing, i.e., the rotation support part 5, and the holder base 4 may be coupled to each other by using, instead of U-shaped hooks, for example, a ball joint, a chain, a wire, or a hinge, to configure a connector holding structure with which the connector 2 can be held by the holder 3 even when the rotation axis of the bearing, i.e., the rotation support part 5, is tilted relative to the vertical direction due to the swinging of the connector 2. With this connector holding structure, an effect similar to that in the fifth embodiment can be obtained.

This means that with the use of at least one of a U-shaped hook, a ball joint, a wire, a hinge, or a chain, it is possible to form a coupling structure of a bearing and the holder base 4 that provides a connector holding structure that produces an effect according to the first embodiment even when the rotation axis of the bearing, i.e., the rotation support part 5, is tilted relative to the vertical direction due to the swinging of the connector 2.

The configurations of the embodiments described above show merely examples of an aspect of the present invention. The techniques in the embodiments can be combined with each other or can be combined with other publicly known techniques, or part of the configurations can be omitted or changed without departing from the scope of the present invention.

### REFERENCE SIGNS LIST

1, 61, 62 electronic device; la casing; 2 connector; 3 holder; 3a holder hole; 4 holder base; 4a holder base recess; 4b enlarged diameter recess portion; 5 rotation support part; 6 securing part; 6a enlarged diameter portion; 7 coupling structure; 7a holder-base-side hook; 7b holder-base-side base part; 7c rotation-support-part-side hook; 7d rotation-support-part-side base part; 11 electric wire; 12 electric wire hanger; 13 electric wire outlet; 21 projection; 31 recess; C central axis of holder.

1. A connector holding structure comprising:
a casing;
an electric wire drawn from an inside to an outside of the casing;
a connector connected at one end to the electric wire and including a projection at another end;
an electric wire hanger provided on one side of the casing and holding a midway portion of the electric wire; and
a holder provided on one side of the casing and having a recess detachably holding the connector by allowing the projection to fit into the recess, wherein
the holder is provided on the one side such that the holder is rotatable around a central axis of the holder extending in a direction in which the projection is fitted into the recess.

2. The connector holding structure according to claim 1, comprising:
a holder base secured to the one side; and
a rotation support part coupled to the holder and the holder base and disposed between the holder and the holder base, the rotation support part supporting the holder such that the holder is rotatable around the central axis of the holder.

3. The connector holding structure according to claim 2, wherein
the holder, the holder base, and the rotation support part are disposed below the electric wire hanger on the one side, and
the holder is placed with the recess facing upward.

4. The connector holding structure according to claim 2, wherein
the holder, the holder base, and the rotation support part are disposed above the electric wire hanger on the one side, and
the holder is placed with the recess facing downward.

5. The connector holding structure according to claim 3, wherein
the holder base serves also as the electric wire hanger, and
the projection is fitted into the recess from below the holder.

6. The connector holding structure according to claim 4, wherein the rotation support part is configured to include a bearing.

7. The connector holding structure according to claim 6, comprising a coupling structure capable of coupling the bearing and the holder base in a state where a rotation axis of the bearing is tilted relative to a vertical direction.

8. The connector holding structure according to claim 7, wherein the coupling structure is configured to include at least one of a U-shaped hook, a ball joint, a wire, a hinge, or a chain.

9. The connector holding structure according to claim 3, wherein
the rotation support part comprises:
a bar-like securing part;
a holder hole formed in an end surface of the holder facing the holder base; and
a holder base recess provided in a side surface of the holder base facing the holder, and
the holder and the holder base are coupled to each other such that the holder is rotatable around the central axis of the holder, by inserting one end of the bar-like securing part into the holder hole and inserting another end of the bar-like securing part into the holder base recess.

10. An electronic device comprising the connector holding structure according to claim 1.

11. The connector holding structure according to claim 4, wherein
the rotation support part comprises:
a bar-like securing part;
a holder hole formed in an end surface of the holder facing the holder base; and
a holder base recess provided in a side surface of the holder base facing the holder, and
the holder and the holder base are coupled to each other such that the holder is rotatable around the central axis of the holder, by inserting one end of the bar-like securing part into the holder hole and inserting another end of the bar-like securing part into the holder base recess.
